(19) United States
(12) Patent Application Publication
(10) Pub. No.: US 2019/0079972 A1
(43) Pub. Date: Mar. 14, 2019

(54) SYSTEM AND METHOD FOR PARALLEL QUERY PROCESSING BASED ON JIT COMPILATION

(71) Applicant: Electronics and Telecommunications Research Institute, Daejeon (KR)

(72) Inventor: Mi Young LEE, Daejeon (KR)

(73) Assignee: Electronics and Telecommunications Research Institute, Daejeon (KR)

(21) Appl. No.: 16/129,407

(22) Filed: Sep. 12, 2018

(30) Foreign Application Priority Data
Sep. 13, 2017 (KR) 10-2017-0117119
Sep. 4, 2018 (KR) 10-2018-0105438

(51) Int. Cl. G06F 17/30; G06F 9/48; G06F 9/445

(52) U.S. Cl. CPC G06F 17/30445; G06F 9/44578; G06F 9/4881; G06F 17/30463

(57) ABSTRACT

The present invention relates to a system and method for parallel query processing by applying just-in-time (JIT) compilation-based query optimization when a query is processed. The system for parallel query processing based on JIT compilation according to the present invention includes a parallel processing scheduler configured to receive a database (DB) operation graph and operation dependency relation and distribute execution tasks and workers configured to execute a query executable code, wherein the workers include a worker for executing a JIT compiled executable code and a worker for executing the query executable code in an interpreter manner.

### CROSS-REFERENCE TO RELATED APPLICATION

This application claims priority to and the benefit of Korean Patent Application No. 2017-0117119, filed on Sep. 13, 2017, and Korean Patent Application No. 2018-0105438, field on Sep. 4, 2018, the disclosure of which is incorporated herein by reference in its entirety.

### BACKGROUND

### 1. Field of the Invention

The present invention relates to a system and method for parallel query processing by applying just-in-time (JIT) query optimization when a query is processed on JIT compilation.

### 2. Discussion of Related Art

An interpreter method and a compilation method are applied to query processing of a database system according to the related art.

The interpreter method according to the related art has a disadvantage in that resources, such as cache and memory, cannot be used efficiently, and the compilation method has to reconfigure an executor every time a query is changed, and there is a compilation overhead.

### SUMMARY OF THE INVENTION

The present invention aims to solve the above-described problems and provide a system and method for parallel query processing based on just-in-time (JIT) compilation, which may perform integrated control even when JIT compilation is performed on a partial query execution plan as well as on a whole query execution plan in intra query parallel processing environment.

According to one general aspect of the present invention, there is a system for parallel query processing based on JIT compilation, including a parallel processing scheduler configured to distribute tasks according to a database (DB) operation graph and operation dependency relation and a plurality of workers configured to execute a query executable code, wherein the workers include a worker for executing a JIT compiled executable code and a worker for executing the query executable code in an interpreter manner.

According to another general aspect of the present invention, there is provided a system for generating a JIT compiled executable code, including: a JIT execution plan optimizer configured to receive a DB operation sub-graph, which is a target for JIT compilation, and basic operation dependency relation, construct extended operation dependency relation, and optimize an intermediate representation (IR)-based sub-execution plan, a JIT execution plan generator configured to construct an IR-based sub-execution plan for parallel processing on the basis of the DB operation sub-graph and the extended operation dependency relation and generate a executable code by compiling the IR-based sub-execution plan, and a JIT query executor configured to control performances of the JIT execution plan optimizer and the JIT execution plan generator.

According to still another general aspect, there is provided a method of parallel query processing based on JIT compilation, including the steps of constructing basic operation dependency relation for parallel processing from a DB operation graph, constructing extended operation dependency relation for a DB operation sub-graph which is a target for JIT compilation, constructing an IR-based sub-execution plan using the DB operation sub-graph and the extended operation dependency relation, constructing a JIT compiled executable code using the IR-based sub-execution plan, scheduling query task on the basis of the extended operation dependency relation, executing an interpreter when a target to be scheduled is not for JIT compilation, and executing a function pointer in the JIT compiled executable code when a target to be scheduled is for JIT compilation.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a parallel query processing system based on just-in-time (JIT) compilation which is applied according to one embodiment of the present invention;

FIG. 2 is a diagram illustrating a parallel query processing architecture of a JIT query executor according to one embodiment of the present invention;

FIG. 3A and FIG. 3B are diagrams illustrating a process of generating a JIT compiled executable code and operation dependency relation for parallel processing according to one embodiment of the present invention;

FIG. 4 is a diagram illustrating an example of a process of JIT compilation-based parallel query processing according to one embodiment of the present invention; and

FIG. 5A and FIG. 5B are flowcharts of JIT compilation-based parallel query processing according to one embodiment of the present invention.

FIG. 6 is a view illustrating an example of a computer system in which a method according to an embodiment of the present invention is performed.

### DETAILED DESCRIPTION OF EXEMPLARY EMBODIMENTS

Advantages, features, and methods for achieving those of the present invention may become apparent upon referring to embodiments described below in detail with reference to the attached drawings.

However, the embodiments are not limited to the embodiments disclosed hereinafter and may be embodied in different ways. The embodiments are provided for perfection of disclosure and for informing those skilled in the art, and the scope of the present invention is defined by the description of the claims.

The terminology used herein is for the purpose of describing the embodiments only and is not intended to be limiting of the present invention. As used herein, the singular forms “a,” “an,” and “the” are intended to include the plural forms as well, unless the context clearly indicates otherwise. It will be further understood that the terms “comprises,” “comprising,” “includes,” and/or “including,” when used herein, specify the presence of stated features, steps, operations, elements, and/or components, but do not preclude the presence or addition of one or more other features, steps, operations, elements, components, and/or groups thereof.

Hereinafter, in order to facilitate understanding by those skilled in the art, the background in which the present invention has been made will be described first, and exemplary embodiments of the present invention will be described in detail.

An interpreter method or a compilation method is generally applied to query processing of a database system.

In the interpreter method, an interpreter which is integrated into a DB engine processes DB operation by interpreting the meaning of each node of the DB operation graph.

In the interpreter method according to the related art, many function calls and branches are occurred when processing a query with the interpreter method, and thus resources, such as a cache, a memory, and the like, cannot be efficiently used.

In the compilation method, an executable code composed of DB operation functions necessary for processing the query and a function that controls an execution of the DB operation functions is generated and compiled for each query.

The compilation method according to the related art improves query processing performance by efficiently utilizing resources, but requires reconfiguration of an executor each time a query is changed, and a compilation overhead occurs.

A just-in-time (JIT) compilation method constructs an intermediate representation (IR)-based code for the query and dynamically optimizes and compiles the IR-based code to generate and process an executable code.

The JIT compilation target may be the entire query execution plan or some operations constituting the query execution plan.

Code optimization provides various syntax-based optimizations and semantic-based optimizations that take a meaning of DB operation into consideration.

In the JIT compilation method, an optimal executable code may be generated by dynamically taking an execution situation into consideration while reusing an IR-based execution plan.

In addition, when an execution situation is not changed, a compiled executable code may be reused.

Therefore, a target for JIT compilation and an IR construction method need to be determined by taking into account a tradeoff between a reusability of code and benefits obtained from optimization by reflecting the dynamic execution environment.

Intra-query parallel processing is widely used to improve query processing performance. In order to enable parallel query processing in a JIT compilation environment, the following three issues should be taken into account.

First, in parallel query processing, dependency relation among nodes constituting a DB operation graph, which is a query execution plan, are analyzed, parts dependent on each other are processed in sequence, and parts not having dependency on each other are processed in parallel. Therefore, in an environment in which JIT compilation is performed on only some operations, integrated scheduling for interpreter-based operations and operations performed by a JIT compiled executable code should be performed.

Second, when various operation nodes are included in a JIT compiled executable code, parallel processing control for the JIT compiled executable code should be also performed according to the relation among the operation nodes and the execution environment.

Third, since a parallel processing environment, such as a set of threads allocated for parallel processing, changes dynamically, intra-query parallelism is generally determined when a query is executed, and parallel processing control is performed using a scheduler or a coordinator. Thus, dependency between the parallel processing environment and the JIT compiled executable code should be disconnected.

The present invention relates to a system for parallel query processing on the basis of JIT compilation and a method thereof, which can provide intra query parallel processing even in a JIT compilation environment.

According to the present invention, integrated parallel processing is possible even when JIT compilation is performed on a partial query execution plan as well as on the whole query execution plan.

In addition, according to the present invention, control of parallel processing the JIT compiled executable code is possible.

Further, according to the present invention, reusability of the JIT generated code is improved even if a parallel processing environment is changed.

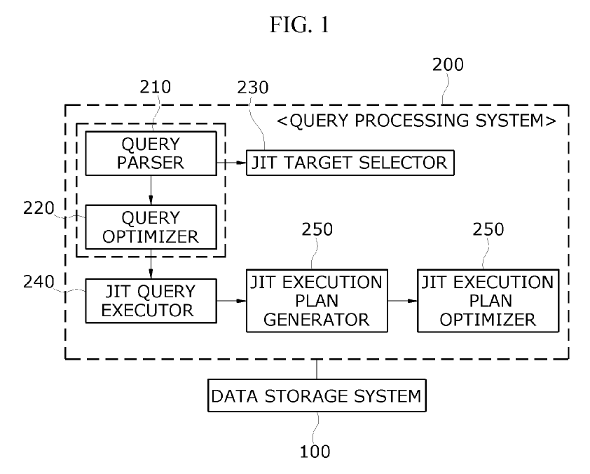

FIG. 1 is a parallel query processing system based on just-in-time (JIT) compilation which is applied according to one embodiment of the present invention

A data storage system 100 performs data storage, concurrency control, and transaction management.

The query processing system 200 performs query parsing, query optimization, and query execution.

The query processing system 200 according to one embodiment of the present invention includes a query parser 210, a query optimizer 220, a JIT target selector 230, a JIT execution plan generator 250, a JIT execution plan optimizer 260, and a JIT query executor 240.

The query-parser 210 generates a parse tree by parsing a query statement.

The query optimizer 220 constructs an optimized execution plan.

The JIT target selector 230 selects a JIT compilation target on the basis of the parse tree received from the query parser 210 or the optimized execution plan received from the query optimizer 220.

The JIT execution plan generator 250 generates an IR-based sub-execution plan for a sub-execution plan on which the JIT compilation is to be performed and constructs a JIT compiled executable code.

The JIT execution plan generator 250 constructs an optimized IR-based execution plan and an optimized executable code by using the JIT execution plan optimizer 260.

The JIT query executor 240 controls the generation of the IR-based sub-execution plan and the executable code and performs query processing by using an interpreter code along with the JIT compiled executable code.

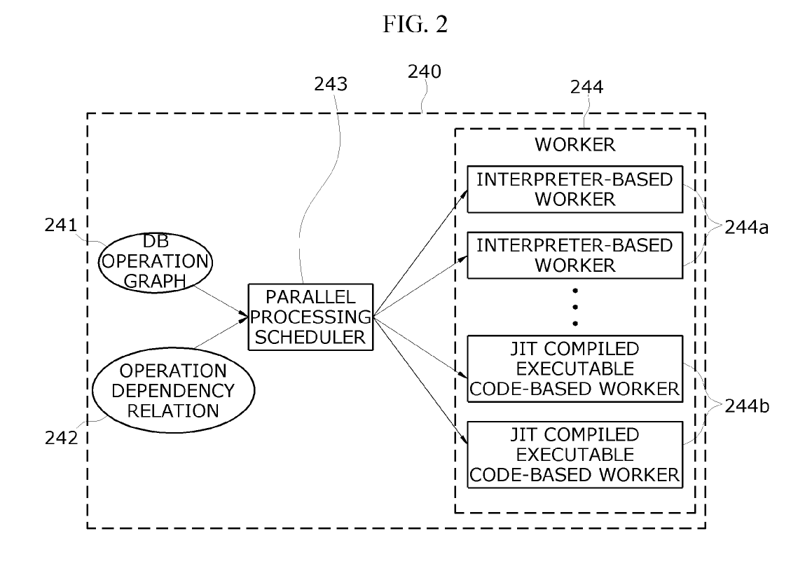

FIG. 2 is a diagram illustrating a parallel query processing architecture of a JIT query executor according to one embodiment of the present invention.

In order to perform parallel processing on dynamically reflecting an execution environment, a parallel processing scheduler 243 in accordance with one embodiment of the present invention schedules DB operation processing-dynamically.

The parallel processing scheduler 243 receives a DB operation graph 241 and operation dependency relation 242 and distributes tasks to be performed to workers 244 allocated for performing actual DB operation, as shown in FIG. 2.

The operation dependency relation 242 is information reconstructed in units capable of parallel processing on the basis of the DB operation graph 241, and the parallel processing may be performed in units of nodes or sub-graphs which constitute the DB operation graph 241.

The operation dependency relation 242 further includes information indicating that operations are JIT compilation targets, a compilation unit name and function name to be called.

The workers 244 according to one embodiment of the present invention include an interpreter-based worker 244a and a JIT compiled executable code-based worker 244b.

The interpreter-based worker 244a receives a range of the DB operation graph which is a target for execution from the parallel processing scheduler 243 and interprets and executes the range of the DB operation graph.

The JIT compiled executable code-based worker 244b receives function pointer to be called in the JIT compiled executable code and executes the corresponding function.

According to one embodiment of the present invention, a specific part of JIT compiled executable code may be executed by constructing a library composed of a set of functions which can be externally called and variably scheduling a JIT compiled executable code externally.

When the JIT query executor 240 performs parallel query processing, the JIT query executor 240 may perform parallel control on the JIT compiled executable code by obtaining relevant information from the operation dependency relation and directly executing a corresponding function pointer.

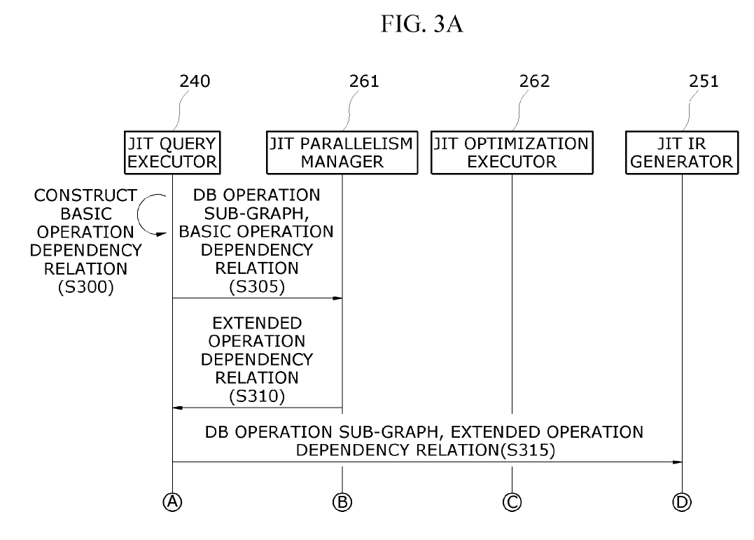

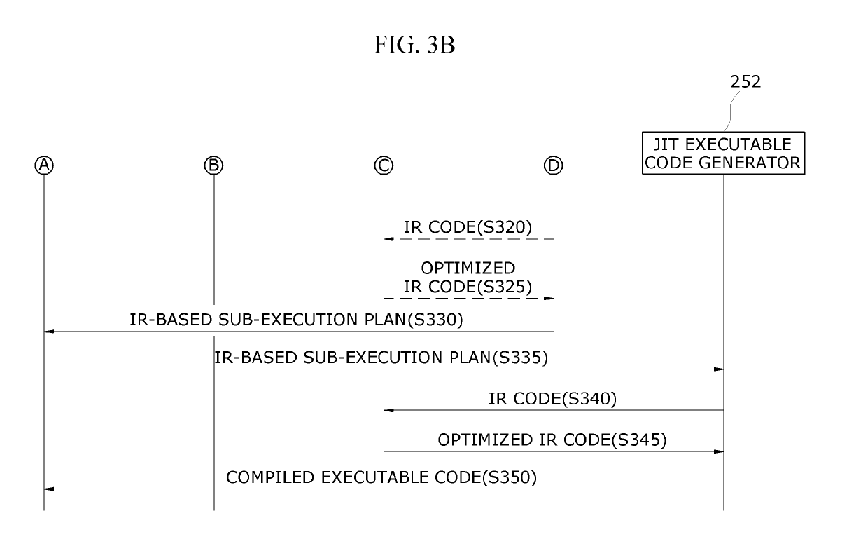

FIG. 3A and FIG. 3B are diagrams illustrating a process of generating a JIT compiled executable code and operation dependency relation for parallel processing according to one embodiment of the present invention.

The process of generating a JIT compiled executable code and operation dependency relation for parallel processing includes steps of configuring basic operation dependency relation, constructing extended operation dependency relation, constructing an IR-based sub-execution plan for parallel processing, optimizing the IR-based sub-execution plan for parallel processing, and generating a compiled executable code. Each of the above steps may be performed or controlled by the JIT query executor 240.

When the above-described information of each step has already been constructed and no change has occurred in a parallel processing environment, the IR-based execution plan or the executable code may be reused and each operation may be integrated as needed.

Referring to FIG. 3A and FIG. 3B, the JIT query executor 240 constructs the basic operation dependency relation on the basis of a DB operation graph by analyzing whether a corresponding operation is to be processed based on a previous operation result (S300).

The basic operation dependency relation, which is information for determining an execution order of operations, is used in parallel query processing scheduling.

A JIT parallelism manager 261 of the JIT execution plan optimizer 260 constructs extended operation dependency relation necessary for control of parallel processing the JIT compiled executable code.

The JIT parallelism manager 261 receives sub-graph information, which is a target for JIT compilation in a DB operation graph and the basic operation dependency relation (S305), constructs the extended operation dependency relation and transmits it to the JIT query executor 240 (S310).

The extended operation dependency relation is information obtained by adding function information, which is to be called corresponding to an operation when a compiled executable code is generated, to the basic operation dependency relation.

The extended operation dependency relation is constructed by taking into account an IR-based sub-execution plan construction method and optimization rules. For example, when code optimization can be performed by dynamic parameter value given in execution, a unit of compilation and a unit of calling function in a compilation target code are determined by taking into consideration such code optimization, and thus the extended operation dependency relation is also constructed by taking the same into consideration.

The JIT query executor 240 transmits the DB operation sub-graph and the extended operation dependency relation to a JIT IR generator 251 in the JIT execution plan generator 250, and the JIT IR generator 251 constructs an IR-based sub-execution plan for parallel processing and transmits it to the JIT query executor 240.

The JIT IR generator 251 constructs the IR-based sub-execution plan by taking into consideration a compilation unit for dynamic compilation and a unit of external call.

For example, it is inefficient to put operations for which dynamic optimization and compilation are required and other operations not required into one unit of compilation. Also operations which can be processed in parallel need to be configured as a separate function, and operations to be processed in sequence can be integrated to construct one function. In addition, when there is a possibility that the function is simultaneously called, the function should be constructed in MT-safe code.

When the JIT IR generator 251 constructs the IR-based sub-execution plan, optimizes it by a JIT optimization executor 262 in the JIT execution plan optimizer 260 as needed.

The JIT optimization executor 262 receives an IR code constituting the IR-based sub-execution plan (S320), selects appropriate optimization rules in consideration of the execution plan and the execution environment and performs the optimization (S325).

In this case, static optimization is performed except for dynamic code optimization caused by dynamic parameter value binding.

A JIT executable code generator 252 of the JIT execution plan generator 250 compiles the IR-based sub-execution plan to generate an executable code (S350).

In the course of generating the executable code, the JIT executable code generator 252 generates a machine code after the JIT optimization executor 262 performs the dynamic code optimization caused by dynamic parameter value binding (S350).

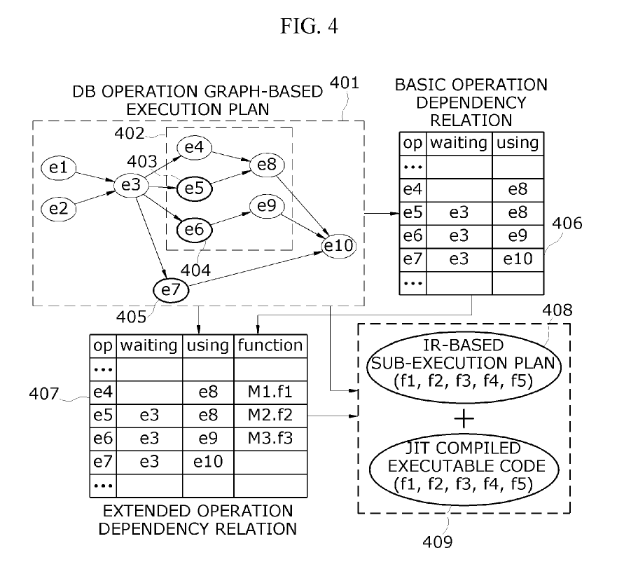

FIG. 4 is a diagram illustrating an example of a process of JIT compilation-based parallel query processing according to one embodiment of the present invention.

For description of one embodiment of the present invention, the following assumptions are made.

1) A DB operation sub-graph 402 is selected as a JIT compilation target.

2) An operation dependency relation is configured for each node of the DB operation graph and there is no reconfiguration, such as integration of operations by optimization.

3) The JIT compilation target is identified using function information included in extended operation dependency relation.

4) The function information includes information like as a unit of compilation and a function name to be called in the unit of compilation.

Referring to FIG. 4, the JIT parallelism manager 261 of the JIT execution plan optimizer 260 receives basic operation dependency relation 406 and a DB operation sub-graph 402 composed of five nodes and constructs extended operation dependency relation 407 in which the function information is reflected.

In FIG. 4, “op” denotes a query operation, “waiting” denotes a preceding operation, and “using” denotes a succeeding operation.

The JIT IR generator 251 of the JIT execution plan generator 250 receives the extended operation dependency relation 407 and the DB operation sub-graph 402 composed of five nodes and constructs an IR-based sub-execution plan 408.

The JIT executable code generator 252 of the JIT execution plan generator 250 generates a JIT compiled executable code 409 by compiling the IR-based sub-execution plan 408.

The JIT query executor 240 executes an interpreter code for an operation, such as e7 405, to be executed by an interpreter on the basis of a DB operation graph-based execution.

In addition, when a target is to be executed in a compiled manner, such as e5 403, the JIT query executor 240 directly executes f2 function pointer, which is a corresponding function in the JIT compiled executable code 409.

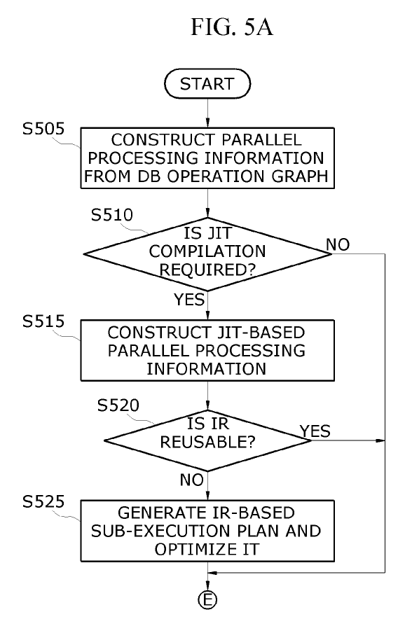

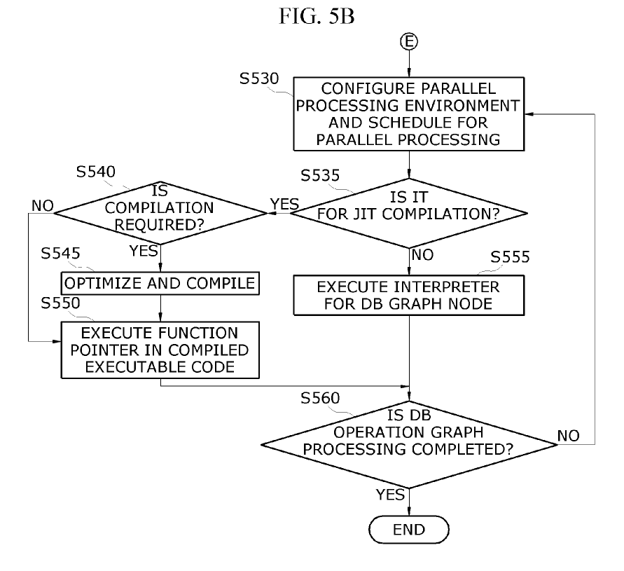

FIG. 5A and FIG. 5B are flowcharts of JIT compilation-based parallel query processing according to one embodiment of the present invention.

According to one embodiment of the present invention, parallel query processing is performed by integrating a JIT compiled executable code and an interpreter code, and the method of parallel query processing shown in FIG. 5 is performed by the JIT execution plan generator 250, the JIT execution plan optimizer 260, and the JIT query executor 240 in cooperation with one another due to receiving execution results from the query parser 210, the query optimizer 220, and the JIT target selector 230.

The JIT query executor 240 constructs basic node dependency relation among operation nodes necessary for parallel processing from a DB operation graph which is an optimized execution plan constructed according to query parsing by the query parser, query optimization by the query optimizer, and the JIT target selector's determination on a JIT target (S505).

Whether the DB operation graph has a part, for which JIT compilation is required (S510), is determined, and when the part, for which JIT compilation is required, exists, the JIT parallelism manager 261 constructs extended operation dependency relation for JIT-based parallel processing with respect to a corresponding DB operation sub-graph (S515).

In constructing the extended operation dependency relation, a unit of compilation and a target to be constructed as a function are determined.

Whether IR for the DB operation sub-graph on which JIT compilation is performed is reusable is checked (S520), and when reusing is not possible, the JIT IR generator 251 constructs an IR-based sub-execution plan from the extended operation dependency information and the DB operation sub-graph information, and the JIT optimization executor 262 performs optimization when necessary (S525).

The IR-based sub-execution plan may be reused for the same execution plan. Therefore, according to management policies, the IR-based sub-execution plan may be reused by storing and managing the same even after a query is executed.

Then, the JIT query executor 240 configures a parallel processing environment, such as thread allocation, and starts parallel processing scheduling on the basis of the DB operation graph and the extended operation dependency relation (S530).

Whether a current target to be scheduled is a target for JIT compilation is checked (S535), and when the target to be scheduled is for JIT compilation, whether compilation is required is checked (S540), and dynamic optimization and compilation are performed when dynamic compilation is required (S545). Thereafter, the JIT query executor 240 executes a function pointer in a compiled executable code (S550).

When it is confirmed in operation S535 that the target to be scheduled is not for JIT compilation, an interpreter is executed and processed (S555).

Then, whether processing of all of the nodes in the DB operation graph is completed is checked (S560), and when not completed, the process returns to operation S530, and when completed, the query processing is terminated.

According to the embodiment of the present invention, a compiled executable code cannot be reused when dynamic optimization is required every time a query is executed.

However, when a dynamic situation is not changed, an executable code may be reused, and thus the compiled executable code may be managed and reused according to management policies.

According to the embodiment of the present invention, an IR-based sub-execution plan and the compiled executable code are stored and managed as needed, and may be reused according to whether reuse is possible in the subsequent query processing.

It may be possible to reuse only the IR-based execution plan or the compiled executable code with the IR-based execution plan.

A part for which JIT compilation is required may be several parts of the DB operation graph constituting the execution plan.

According to the embodiment of the present invention, compiled executable codes may be configured separately for each target for JIT compilation or may be configured to be partially integrated according to an optimization method to be applied thereto.

As described above, according to the embodiment of the present invention, a part which is changed due to an external parallel processing environment is configured as extended operation dependency relation.

In addition, an integrated control on DB operations by an interpreter code and a compiled executable code for parallel processing based on extended operation dependency relation is possible, and an IR-based execution plan or a compiled executable code is easily reused.

In addition, when an IR-based sub-execution plan is constructed, a unit of compilation is determined and functionalization is performed by taking into consideration an optimization method and a unit of parallel processing control so that a JIT compiled executable code can be constructed such that optimal parallel processing is performable.

According to the embodiment of the present invention, it is possible to improve parallel query processing performance on the basis of JIT compilation.

Parallel query processing is performed by optimizing a part for which code optimization by JIT compilation is possible and integrating a JIT compiled executable code and an interpreter code so that it is possible to improve query processing performance.

According to the embodiment of the present invention, it is possible to improve reusability of a IR-based execution plan and an executable code.

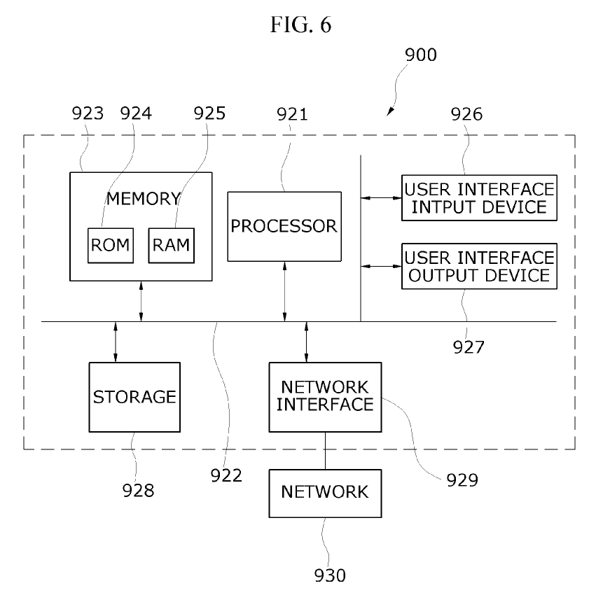

The method according to an embodiment of the present invention may be implemented in a computer system or may be recorded in a recording medium. FIG. 6 illustrates a simple embodiment of a computer system. As illustrated, the computer system may include one or more processors 921, a memory 923, a user input device 926, a data communication bus 922, a user output device 927, a storage 928, and the like. These components perform data communication through the data communication bus 922.

Also, the computer system may further include a network interface 929 coupled to a network. The processor 921 may be a central processing unit (CPU) or a semiconductor device that processes a command stored in the memory 923 and/or the storage 928.

The memory 923 and the storage 928 may include various types of volatile or non-volatile storage mediums. For example, the memory 923 may include a ROM 924 and a RAM 925.

Thus, the method according to an embodiment of the present invention may be implemented as a method that can be executable in the computer system. When the method according to an embodiment of the present invention is performed in the computer system, computer-readable commands may perform the producing method according to the present invention.

The method according to the present invention may also be embodied as computer-readable codes on a computer-readable recording medium. The computer-readable recording medium is any data storage device that may store data which may be thereafter read by a computer system. Examples of the computer-readable recording medium include read-only memory (ROM), random access memory (RAM), CD-ROMs, magnetic tapes, floppy disks, and optical data storage devices. The computer-readable recording medium may also be distributed over network coupled computer systems so that the computer-readable code may be stored and executed in a distributed fashion.

The effects of the present invention are not limited to those mentioned above, and other effects not mentioned may be clearly understood by those skilled in the art from the above-described detailed description.

The foregoing description of the invention is for illustrative purposes, a person having ordinary skilled in the art should appreciate that other specific modifications may be easily made thereto without departing from the technical spirit or essential features of the invention. Therefore, the foregoing embodiments should be regarded as illustrative rather than limiting in all aspects. The scope of the present invention is not defined by the detailed description as set forth above but by the accompanying claims of the invention. It should also be understood that all changes or modifications derived from the definitions and scopes of the claims and their equivalents fall within the scope of the invention.

### REFERENCE NUMERALS

100: DATA STORAGE SYSTEM 200: QUERY PROCESSING SYSTEM
210: QUERY PARSER 220: QUERY OPTIMIZER
230: JIT TARGET SELECTOR 240: JIT QUERY EXECUTOR
241: DB OPERATION GRAPH 242: OPERATION DEPENDENCY RELATION
243: PARALLEL PROCESSING SCHEDULER 244: WORKER
244A: INTERPRETER-BASED WORKER
244B: JIT COMPILED EXECUTABLE CODE-BASED WORKER
250: JIT EXECUTION PLAN GENERATOR
251: JIT IR GENERATOR
252: JIT EXECUTABLE CODE GENERATOR
260: JIT EXECUTION PLAN OPTIMIZER
261: JIT PARALLELISM MANAGER
262: JIT OPTIMIZATION EXECUTOR
401: DB OPERATION GRAPH-BASED EXECUTION PLAN
406: BASIC OPERATION DEPENDENCY RELATION
407: EXTENDED OPERATION DEPENDENCY RELATION
408: IR-BASED SUB-EXECUTION PLAN
409: JIT COMPILED EXECUTABLE CODE

What is claimed is:

1. A system for parallel query processing based on just-in-time (JIT) compilation, comprising:
a parallel processing scheduler configured to distribute tasks according to a database (DB) operation graph and operation dependency relation among operations; and
workers including a JIT compiled executable code and an interpreter code for DB operation and configured to perform query processing.

2. The system of claim 1, wherein the operation dependency relation includes basic dependency relation for determining an execution order of operations for which parallel processing is required and further includes extended dependency relation to which call function information for an operation, for which JIT compilation is required, is added.

3. The system of claim 1, wherein, by using the operation dependency relation, the parallel processing scheduler transmits the interpreter code and an execution range of the DB operation graph to the workers for query processing when an operation is not for JIT compilation, and the parallel processing scheduler transmits a call function pointer in the JIT compiled executable code to the worker for query processing when an operation is for JIT compilation.

4. A system for generating a just-in-time (JIT) compiled executable code, comprising:
a JIT execution plan optimizer configured to receive a database (DB) operation sub graph, which is a target for JIT compilation, and basic operation dependency relation, construct extended operation dependency relation, and optimize an intermediate representation (IR)-based sub-execution plan;
a JIT execution plan generator configured to construct an IR-based sub-execution plan for parallel processing on the basis of the DB operation sub-graph and the extended operation dependency relation and generate a executable code by compiling the IR-based sub-execution plan; and
a JIT query executor configured to further control performances of the JIT execution plan optimizer and the JIT execution plan generator.

5. The system of claim 4, wherein the JIT execution plan optimizer constructs the extended operation dependency relation including call function information by taking into account an IR-based sub-execution plan construction method, optimization rules, and the like.

6. The system of claim 4, wherein the JIT execution plan generator constructs the IR-based sub-execution plan by taking into account a unit of dynamic compilation and a unit of external call.

7. The system of claim 4, wherein the IR-based sub-execution plan and the compiled executable code is managed and reused according to management policies.

8. A method of parallel query processing based on just-in-time (JIT) compilation, comprising the steps of:
(a) constructing basic operation dependency relation for parallel processing from a database (DB) operation graph;
(b) constructing extended operation dependency relation for a DB operation sub-graph which is a target for JIT compilation;
(c) constructing an intermediate representation (IR)-based sub-execution plan using the DB operation sub-graph and the extended operation dependency relation;
(d) constructing a JIT compiled executable code using the IR-based sub-execution plan;
(e) scheduling query task on the basis of the extended operation dependency relation;
(f) executing an interpreter when a target to be scheduled in step (e) is not for JIT compilation; and
(g) executing a function pointer in the JIT compiled executable code when a target to be scheduled in step (e) is for JIT compilation.

9. The method of claim 8, wherein the step (b) includes constructing the extended operation dependency relation including call function information by taking into consideration an IR-based sub-execution plan construction method, optimization rules, and the like.

10. The method of claim 8, wherein the step (c) includes constructing the IR-based sub-execution plan by taking into account a unit of dynamic compilation and a unit of external call.

11. The method of claim 8, further comprising, prior to the step (c), checking whether IR for the DB operation sub-graph which is a target for JIT compilation is reusable.

12. The method of claim 8, further comprising, prior to the step (d), checking whether the compiled executable code is reusable.
